(19) United States
(12) Patent Application Publication
(10) Pub. No.: US 2006/0074712 A1
(43) Pub. Date: Apr. 6, 2006

(54) Systems and methods for supplying a useful collection of medical coding data

(76) Inventors: Kelly R. Jorgensen, Mill Creek, WA (US); Richard Anthony Sutton, San Jose, CA (US); Jeffrey C. Wolf, Phoenix, AZ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/956,690

(22) Filed: Oct. 1, 2004

(51) Int. Cl. G06Q 50/00

(52) U.S. Cl. 705/2

(57) ABSTRACT

Upon request, a computer can provide a useful collection of medical coding data to another computer on a network. The collection can be tailored to a particular medical specialty. The collection can be provided in a printable form that relates the various code relationships which may be needed for accurate use of the codes. Various embodiments may provide a book with a separate page for each code that includes the fee for the code, codes that are mutually exclusive with the code, and codes that may be needed in addition to the code. Other useful information can also be associated with the codes provided in the collection. Appropriate fees for codes in the collection can be provided, which may need to be calculated for each medical services provider depending on variables such as a geographic location of the medical service provider.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to reimbursement for medical services, and more particularly to identifying and supplying useful and updateable collections of medical billing data across a computer network such as the internet.

### BACKGROUND OF THE INVENTION

Medical providers are eligible for the receipt of payments from governmental agencies as well as private insurance companies upon providing certain care and procedures. Providers are required by statute, regulation, and/or private insurance contractual rules to meet particular standards in reporting services and requesting payment. In general, meeting the reporting standards entails recording and submitting the proper codes for the procedures that a medical provider carries out. For example, if a patient visits a provider for a broken finger, an associated code can be submitted to a paying entity such as Medicare.

Medical encounter documentation and coding is increasingly complex. Health Care Financing and Medicare rules may require documentation of multiple items for every patient seen. Codes to identify care and/or procedures may come from a variety of different sources, and there may be no centralized location to easily access all of the codes that are needed for a particular practice specialty. Further complicating matters, some codes are considered incompatible with other codes. Additionally, some codes may be used only within particular geographical areas. The amount of payment a provider is entitled to can also vary from region to region. It is ever more difficult for the provider to remember, interrelate, and document all of the necessary individual reimbursement codes. Increases in staffing has been recommended as a means of addressing the burden of correct coding to insure the submission of reimbursement requests which comply with regulatory requirements. The provider is thus required to expend additional resources, and remains exposed to the hazard of incorrectly coding the procedures that were done, and being subjected to civil and even criminal sanctions.

In some cases, failure to correctly code can result in charges of the commitment of fraud and abuse in requesting and receiving payment. Incorrect coding may likely result in noncompliance with laws or regulations such as the Federal False claims Act (31 USC 3729), the Health Insurance Portability and Accountability Act (HIPAA), Stark I and II and similar Federal and State laws enacted to protect against fraudulent claims for reimbursement for the providing of health care. Medical providers are thus exposed to criminal and civil penalties relating to compliance with regulatory and statutory requirements.

Due to the complexity of Evaluation and Management Coding (E&M coding), the potential for error in such coding, and the potential severity of penalty for noncompliance, many providers deliberately under-code patient encounters resulting in a loss of revenue to the provider. Some estimate that as many as 80% of providers under-code from fear of unintentional noncompliance and resulting legal action.

Various attempts to provide coding resources for providers have failed to adequately address the problem. First, providers can attempt to find the codes they need from the various sources of codes themselves. This solution is almost unworkable, because of the variety of needed codes and the constant need to update the codes. Moreover, the various relationships between codes may not be easily understood. Guides exist for use by providers including “A Blueprint For Documenting Your E&M Services”, Conomikes Medicare Hotline, November 1997, Vol. 7, Number 1 revised 1998 and St. Anthony's “Guide to Evaluation and Management Coding and Documentation”, Third Edition. However, these guides can quickly become out of date as coding procedures in the industry change. Codes are changed as new procedures are identified and as Medicare and other payment policy-setting organizations change their protocols.

Another available solution is internet or on-line coding resources, such as CODE CORRECT® available at www.codecorrect.com. The advantage of on-line coding resources is that they can be kept up-to date, and can link to the various codes that may be needed in various settings, thereby providing useful help with the relationships between codes. The disadvantage is that providers may not always have an internet connection available, and if they do, they may consider it cumbersome to constantly check on-line prior to coding for a particular procedure. Internet sites are not conveniently printed and saved in a file for physical reference, because the linking function is typically critical to their use. In other words, a plurality of first codes my be provided on a first webpage, and each code may be linked to related codes. To display the related codes, a user may select one of the plurality of first codes. Thus, if the webpages of such a website are printed to paper form, the linking feature is lost and the relationships between codes becomes difficult to decipher.

In light of the above described deficiencies in the art, there is a need in the industry to provide coding information to medical service providers in a manner that better facilitates accurate, fast, up-to-date, and understandable compliance with the codes and code rules of paying entities.

### SUMMARY OF THE INVENTION

Systems and methods for providing a useful collection of medical coding data can make use of a computer connected to a computer network. Upon request, the computer can provide a useful collection of medical coding data to another computer on the network. The collection may then be used by a medical services provider, and updated as necessary. The collection can be tailored to a particular medical specialty. The collection can be provided in a printable form that relates the various code relationships which may be needed for accurate use of the codes. Various embodiments may provide a book with a separate page for each code that includes the fee for the code, codes that are mutually exclusive with the code, and codes that may be needed in addition to the code. Other useful information can also be associated with the codes provided in the collection. Appropriate fees for codes in the collection can be provided, which may need to be calculated for each medical services provider depending on variables such as a geographic location of the medical service provider. Additional aspects of the invention are described below.

### BRIEF DESCRIPTION OF THE DRAWINGS

FIG. 1 illustrates a system in which a plurality of data sources 12-16 are coupled to a computer 10 via a network 18. Data from sources 12-16 may be stored locally in data storage 11, and may represent the various medical procedure codes used by physicians to receive payment for services rendered, as well as relationships between the codes, data for calculating appropriate fees for the codes, and additional information that may be usefully supplied along with the codes.

FIG. 2 illustrates the general features of a computing environment 200 in which software can be implemented to carry out the various functions described herein.

FIG. 3 illustrates a computer network, components of which may be utilized in connection with the various functions and processes herein.

FIG. 4A illustrates an exemplary data storage 400 that contains medical coding data. The various procedure codes can be associated with any of a plurality of exemplary specialties 401, 402, 403, 404. Some of the codes associated with a specialty, for example optional procedures 401a which are associated with specialty A procedures 401, can be included in a useful collection of codes associated with a specialty if selected. Other codes, for example additional procedures 405, can be included in a collection if independently referenced by a user.

FIG. 4B illustrates an exemplary user interface (UI) which allows a user to select a medical specialty associated with a collection of procedure codes.

FIG. 4C illustrates an exemplary UI which presents a plurality of selectable procedure code groups and allows a user to select code groups in addition to codes that may be automatically selected for users of a particular specialty. The exemplary UI also provides an area for entry of additional user specific codes.

FIG. 5 illustrates a series of steps that may be engaged to provide a user with a useful collection of codes along with related data to facilitate the use of the codes. In general, the steps comprise receiving information from a user and generating a document with a collection of codes pertaining to the user's specialty. The codes can be associated with fees calculated according to the user's circumstances, and with any mutually exclusive and/or local codes that may be needed by a particular user.

FIG. 6 illustrates an exemplary page of a document that may be associated with one procedural code in a collection of codes that is transmitted to a medical services provider. The page 68 may identify a procedure code 60, a permissible fee 61 for the associated procedure 62, and various notes 63, additional information 64 and related codes 65-67 as described in greater detail below.

FIG. 7 illustrates exemplary steps that may be carried out in updating a collection that was previously provided to a user.

FIG. 8 illustrates aspects of various embodiments of the invention in which a network application 80 can access data tables 81 that may comprise codes and other data from a plurality of sources 82a-82e. The network application 80 may accept input such as fee variables 83a and a plurality of codes associated with a specialty designation 84a. The network application 80 may generate a document 85 in which data from 82a-82e is conveniently associated with codes of the collection specified by the user. Moreover, the network application 80 may send out updates 88 as the data in 82a-82e changes, or on a regular interval, such as quarterly.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology and/or medical coding are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

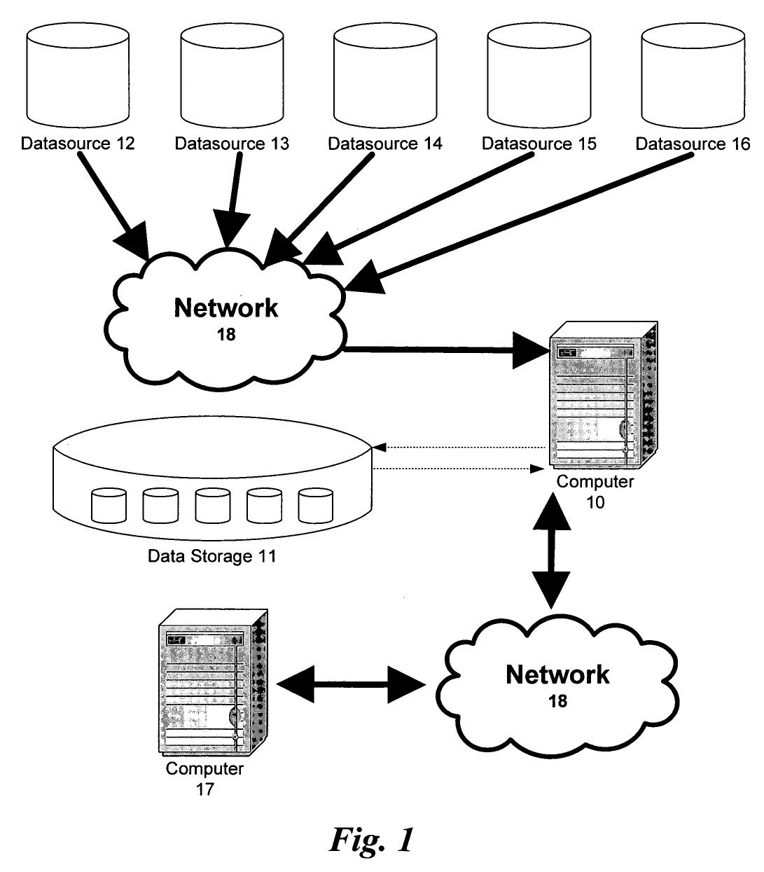

FIG. 1 illustrates a system in which a plurality of data sources 12-16 are coupled to a computer 10 via a network 18. Data from sources 12-16 may be stored locally in data storage 11, as represented by the miniature cylinders in data storage 11. While it is convenient to store data locally for speed and reliability of access to the data storage 11, data can in theory be accessed anywhere on a computer network and it is not necessary to store it locally in 11. Instead, the data in 11 may be accessed directly and continuously from sources 12-16 and/or from various other secondary sources that provide the function of retrieving, storing, and providing access to data that is supplied by the desired sources 12-16. In general, data from 12-16 may represent the various medical procedure codes used by physicians to receive payment for services rendered, in addition to any relationships between the codes, data for calculating appropriate fees for the codes, and additional information that may be usefully supplied along with the codes. The following discussion is directed to the commonly used data in modern medical practices, but it should be understood that the sources and format of the data can and do change over time, and the invention is not limited to any particular source or format for the data.

Exemplary First Data Source

In various embodiments, a first data source 12 can be Current Procedural Terminology, or CPT® codes provided by the American Medical Association, or AMA®. The AMA® publishes CPT® codes that have become standard in the industry for use in identifying medical procedures for the purpose of reimbursement for services rendered. While preferred embodiments of the invention make use of CPT® codes as a first data source 12, it should be understood that any source of codes or identifiers of medical services are similarly workable. CPT® codes are widely used in the industry and therefore of particular value, however, there may be private insurance companies, for example, that develop and use their own set of codes to identify medical procedures so that medical providers can submit claims and be paid. There may be such systems extant outside of the medical industry as well, although the medical industry is considered particularly ripe for implementation of the technology described herein.

More particularly, with respect to CPT® codes, these codes are maintained and frequently updated, which imposes a burden on medical providers who use them. The CPT® codes are presently published in a fourth edition. CPT®, Fourth Edition, is a listing of descriptive terms and identifying codes for reporting medical services and procedures. The purpose of CPT® is to provide a uniform language that accurately describes medical, surgical, and diagnostic services, and thereby serves as an effective means for reliable nationwide communication among physicians, and other healthcare providers, patients, and third parties.

CPT® descriptive terms and identifying codes currently serve a wide variety of descriptive functions. For example, a CPT® code may be used to identify a surgical operation, such as an appendectomy, or a drug prescription, or an evaluation and management (E & M) service such as patient intake processing. This system of terminology is presently the most widely accepted medical nomenclature used to report medical procedures and services under public and private health insurance programs. CPT® is also used for administrative management purposes such as claims processing and developing guidelines for medical care review.

The AMA® first developed and published CPT® in 1966. The first edition helped encourage the use of standard terms and descriptors to document procedures in the medical record; helped communicate accurate information on procedures and services to agencies concerned with insurance claims; provided the basis for a computer oriented system to evaluate operative procedures; and contributed basic information for actuarial and statistical purposes.

The first edition of CPT® contained primarily surgical procedures, with limited sections on medicine, radiology, and laboratory procedures. The second edition was published in 1970, and presented an expanded system of terms and codes to designate diagnostic and therapeutic procedures in surgery, medicine, and other specialties. At that time, a five-digit coding system was introduced, replacing the former four-digit classification. Another significant change was a listing of procedures relating to internal medicine.

In the mid to late 1970s, the third and fourth editions of CPT® were introduced. The fourth edition, published in 1977, represented significant updates in medical technology and a system of periodic updating was introduced to keep pace with the rapidly changing medical environment. In 1983, CPT® was adopted as part of the Centers for Medicare and Medicaid Services (CMS), formerly Health Care Financing Administration's (HCFA), Healthcare Common Procedure Coding System (HCPCS). With this adoption, CMS mandated the use of HCPCS to report services for Part B of the Medicare Program. In October 1986, CMS also required state Medicaid agencies to use HCPCS in the Medicaid Management Information System. In July 1987, as part of the Omnibus Budget Reconciliation Act, CMS mandated the use of CPT® for reporting outpatient hospital surgical procedures.

Today, in addition to use in federal programs (Medicare and Medicaid), CPT® is used extensively throughout the United States as the preferred system of coding and describing health care services. The Administrative Simplification Section of the Health Insurance Portability and Accountability Act (HIPAA) of 1996 requires the Department of Health and Human Services to name national standards for electronic transaction of health care information. This includes; transactions and code sets, national provider identifier, national employer identifier, security, and privacy. The Final Rule for transactions and code sets was issued on Aug. 17, 2000. The rule names CPT® (including codes and modifiers) and HCPCS as the procedure code set for:

Physician services.

Physical and occupational therapy services.

Radiological procedures.

Clinical laboratory tests.

Other medical diagnostic procedures.

Hearing and vision services.

Transportation services including ambulance.

The Final Rule also named ICD-9-CM volume 1 and 2 as the code set for diagnosis codes, ICD-9-CM volume 3 for inpatient hospital services, CDT for dental services, and NDC codes for drugs. These additional medical coding data sources may be used in addition to the CPT® codes in various embodiments of the invention.

All health care plans and providers who transmit information electronically were required to use established national standards by the end of the implementation period, Oct. 16, 2003. In addition, all local codes have been eliminated and national standard code sets must be used after Oct. 16, 2003. Thus, the CPT® codes are a preferable candidate for use in identifying medical procedures for the purpose of reporting services rendered, because these codes are already used in the industry and in some cases even required by law.

The CPT® Editorial Panel is responsible for maintaining the CPT® nomenclature. The AMA has established procedures for addressing suggestions to revise CPT, adding or deleting a code, or modifying existing nomenclature. In general, if all AMA advisors concur that a change should be made, or if two or more advisors disagree or give conflicting information, the issue is referred to the CPT® Editorial Panel for resolution. The CPT® Editorial Panel meets quarterly, addressing the complex problems associated with new and emerging technologies, as well as the difficulties encountered with outmoded procedures. The Panel addresses nearly 350 major topics a year, which typically involve more than 3,000 votes on individual items. The Panel actions can result in three outcomes:

add a new code or revise existing nomenclature, in which case the change would appear in a forthcoming volume of CPT;

postpone/table an item to obtain further information; or reject an item.

In this regard, it is generally unpredictable whether the editorial board will add, postpone or reject an item. In an environment where correct coding may be enforced by law, including both civil and criminal penalties, medical providers require frequent and accurate updates to CPT® codes which they use. Some predictability is provided by a timed release of new codes. Codes for performance measurement are released biannually (January 1 and July 1) on the AMA CPT® internet site, http://www.ama-assn.org/go/CPT® and published annually in the CPT® book as part of the general CPT® code set. Codes released on January 1 st are effective July 1st, allowing 6 months for implementation, and codes released on July 1 st are effective January 1 st. However, medical providers in a given specialty do not know whether newly released codes affect their particular niche without periodically checking the newly released codes. This can be burdensome for medical providers.

There currently exist a variety of categories of CPT® codes, and any category may be used exclusively or along with other categories in implementations of the invention. Category I CPT® codes describe a procedure or service identified with a five-digit CPT® code and descriptor nomenclature. Although this is the present format for CPT codes, other code formats and other techniques for identifying procedures/medical care are also feasible for use in embodiments of the invention. The inclusion of a descriptor and its associated specific five-digit identifying code number in this category of CPT® codes is generally based upon the procedure being consistent with contemporary medical practice and being performed by many physicians in clinical practice in multiple locations.

CPT® Category II codes are supplemental tracking codes that can be used for performance measurement. The use of the tracking codes for performance measurement will decrease the need for record abstraction and chart review, and thereby minimize administrative burdens on physicians and other health care professionals. These codes are intended to facilitate data collection about quality of care by coding certain services and/or test results that support performance measures and that have been agreed upon as contributing to good patient care. Some codes in this category may relate to compliance by the health care professional with state or federal law. The use of these codes is considered optional under law. The Category II codes are not required for correct coding under current laws (although this could change in time) and generally may not be used as a substitute for Category I codes.

Services/procedures or test results described in Category II make use of alpha characters as the 5th character in the string (i.e., 4 digits followed by an alpha character). These digits are not intended to reflect the placement of the code in the regular (Category I) part of the CPT® code set. Also, these codes describe components that are typically included in an evaluation and management service or test results that are part of the laboratory test/procedure. Consequently, they do not have a relative value associated with them.

Category III CPT® codes are a temporary set of tracking codes for new and emerging technologies. These codes are intended to facilitate data collection on and assessment of new services and procedures. The Category III codes are intended for data collection purposes in the FDA approval process or to substantiate widespread usage. As such, the Category III codes may not conform to the usual CPT® code requirements for Category I. The Panel has established the following criteria for evaluating Category III code requests, any one of which is sufficient for consideration by the Editorial Panel: 1) a protocol for a study of procedures being performed; 2) support from the specialties who would use the procedure; 3) availability of U.S. peer-reviewed literature; 4) descriptions of current United States trials outlining the efficacy of the procedure.

These codes will be assigned a numeric-alpha identifier (eg, 1234T). These codes will be located in a separate section of CPT, following the “Category II” section. Introductory language in this code section explains the purpose of the Category III codes.

Once approved by the Editorial Panel, the newly added Category III CPT® codes are released biannually (January 1 and July 1) on the AMA CPT® internet site, http://www.ama-assn.org/go/CPT® and published annually in the CPT® book as part of the general CPT® code set. Codes released on January 1 st are effective July 1 st, allowing 6 months for implementation, and codes released on July 1 st are effective January 1 st.

Category III CPT® codes are not referred to the AMA/Specialty RVS Update Committee (RUC) for valuation because no relative value units (RVUs) will be assigned. Payment for these services/procedures is based on the policies of payers and local Medicare Carriers. However, the assignment of a CPT® Category III code to a service does not indicate that it is experimental or of limited utility, but only that the service or technology is new and is being tracked for data collection. In the Final Rule for the 2002 Medicare Physician Fee Schedule (Federal Register, Thursday, Nov. 1, 2001), the Center for Medicare and Medicaid Services (CMS) stated that they believed that Category III codes “will serve a useful purpose” and that payment for the service is at the discretion of the Carriers, but that the codes could be paid after entered into the computer systems. Local payment determination is reasonable for Category III CPT® codes. It is not reasonable to categorically deny payment for CPT® Category III codes since they are effectively more specific, more functional versions of unlisted codes which many payers cover with appropriate documentation. Once payment policies are established of a Category III Code, the need for documentation will be minimized since Category III Codes are associated with unique and specific descriptions of the service or procedure. Since Category III codes are part of the CPT® code set, all health care payers must be able to accept Category III codes into their systems to comply with the standards for transactions and code sets under HIPAA.

These codes will be archived 5 years from the date of implementation, if the code has not been accepted for placement in the Category I section of CPT, unless demonstrated that a Category III code is still needed. Unaccepted Category III codes are presently barred from reuse.

Exemplary Second Data Source

In various embodiments, a second data source 13 can be one or more Relative Value Unit (RVU) tables. An RVU is a number that is typically associated with a CPT code. In fact, there may be several RVUs associated with a CPT code. Different medical providers are not necessarily entitled to charge the same amount for the same procedure. Instead, the amount that may be charged, i.e. the fee, may vary based on a number of variables. These variables will be discussed further below. Typically the fee for a particular procedure is calculated, in part, by multiplying the RVUs for that procedure by the variables that apply for a particular provider. Complicating matters somewhat, RVUs may comprise to components, the RVU itself and a conversion factor. For example, if an RVU is 0.5, and a conversion factor is 100, then the number 50 can be used in conjunction with other variables to determine a fee for services rendered.

For example, if a repair of a broken finger has a 0.5 RVU and a conversion factor of 200 (thereby yielding, in combination, the number 100), then a hypothetical provider in Seattle, Wash., may multiply by a geographic variable, for example, of 2.5, and therefore be entitled to charge $250 for the procedure. A provider in Spokane, Wash. conducting the same procedure may instead multiply by a geographic variable of 0.8, and therefore only be allowed to charge $80 for the procedure. Again, a more detailed explanation of the potential variables is set forth below.

Regarding the RVUs, in 1992, Medicare significantly changed the way it pays for physicians' services. Instead of basing payments on charges, the federal government established a standardized physician payment schedule based on a resource-based relative value scale (RBRVS). In the RBRVS system, payments for services are determined by the resource costs needed to provide them. The cost of providing each service is divided into three components: physician work, practice expense and professional liability insurance. Payments are calculated by multiplying the combined costs of a service by a conversion factor (a monetary amount that is determined by the Centers for Medicare and Medicaid Services). Payments are also adjusted for geographical differences in resource costs.

The physician work component accounts, on average, for 55% of the total relative value for each service. The initial physician work relative values were based on the results of a Harvard University study. The factors used to determine physician work include the time it takes to perform the service; the technical skill and physical effort; the required mental effort and judgment; and stress due to the potential risk to the patient. The physician work relative values are updated each year to account for changes in medical practice. Also, the legislation enacting the RBRVS requires the Centers for Medicare and Medicaid Services (CMS) to review the whole scale at least every five years.

The practice expense component of the RBRVS accounts for an average of 42% of the total relative value for each service. Up until recently, practice expense relative values were based on a formula using average Medicare approved charges from 1991 (the year before the RBRVS was implemented) and the proportion of each specialty's revenues that is attributable to practice expenses. However, in January 1999, CMS began a transition to resource-based practice expense relative values for each CPT code that differ based on the site of service. In 2002, the resource-based practice expenses became fully transitioned.

On Jan. 1, 2000, CMS implemented the resource-based professional liability insurance (PLI) relative value units. With this implementation and final transition of the resource-based practice expense relative units on Jan. 1, 2002, all components of the RBRVS are now resource-based.

Exemplary Third Data Source

In various embodiments, a third data source 14 can be an up-to-date geographic practice cost index (GPCI). The GPCI is a geographic variable that can be multiplied by an RVU, in addition to any other variables, to arrive at an appropriate fee for a procedure. The third data source can also contain any such other variables that may be used in conjunction with the RVUs to determine an appropriate fee for a particular provider.

Presently, a GPCI is used by Medicare as well as some private insurance companies to adjust for variance in operating costs of medical practices located in different parts of the country. Reimbursement of Physicians for services performed under Medicare is governed by a formula that considers the product of three factors:

A nationally uniform relative value unit (RVU) for the service;

A GPCI value which adjusts each RVU component (Work, Practice Expense, malpractice); and

A nationally uniform conversion factor for the service.

The Conversion Factor converts the relative values into payment amounts. For each physician fee schedule service, which is represented by an associated Health Care Common Procedure Coding System (HCPCS) code, there are presently three relative values:

An RVU for physician work;

An RVU for practice expense;

An RVU for malpractice expense.

For each of these components, there is a GPCI which adjusts the RVU value based on a practices geographic location. The GPCIs reflect the relative costs of practice expenses, malpractice insurance, and physician work in an area compared to the national average for each component.

For example, if a medical services provider is located in Los Angeles, Calif., the GPCI values may be as follows:

Practice Location: Los Angeles, Calif.

Work GPCI: 1.056

Practice GPCI: 1.139

Malpractice GPCI: 0.955

Carrier/Location: 31146/18

The general formula presently used for calculating the Medicare fee schedule amount for a given service in a given fee schedule area can be expressed as:
Payment=[(RVU work×GPCI work)+(RVU practice expense×GPCI practice expense)+(RVU malpractice×GPCI malpractice)]×Conversion Factor

So, to calculate the amount that Medicare will reimburse a provider with a practice located in Los Angeles, Calif. for a Diagnostic Colonoscopy (CPT/HCPCS 45378-53), the following calculation can be used:
$93.36=[(0.96×1.056)+(1.29×1.139)+(0.07×0.955)]×36.6137

Thus, a GPCI is a measure of the differences in resource costs among physician fee schedule areas. There are presently three GPCIs, one for each RVU component: a work GPCI, an overhead GPCI, and a malpractice GPCI. These three GPCIs can be used in conjunction with RVUs for a particular CPT procedure to determine the appropriate fee for the procedure. Therefore, embodiments of the invention may keep or access current CPT, RVU, and GPCI data so that, upon request from a provider, a plurality of CPT codes can be supplied with pre-calculated fees for the associated procedures which are accurate for the particular provider's circumstances.

Exemplary Fourth Data Source

Note that while the above three exemplary data sources can be used to calculate appropriate fees, there is additional information associated with the above described procedure codes which is useful for providers making use of such codes. Various embodiments of the invention can store and provide such additional information. Preferred embodiments supply both the fee and additional information for a desirable subset of procedure codes that is tailored to a particular provider's practice.

In this regard, various embodiments may comprise a fourth data source 15, with National Correct Coding Initiative (NCCI) or similar data. NCCI data identifies pairs of services that normally should not be billed by the same physician for the same patient on the same day. In this regard, NCCI provides codes that are not concurrently reimbursable with the various procedure codes. As such, NCCI provides a plurality of relationships between CPT codes. If a first CPT code is used, it may be inappropriate to use another identified code with respect to the same patient encounter. For example, if a first code identifies a left hand amputation, it may be inappropriate to submit a code for a left hand finger amputation with respect to the same patient. In medical coding, there are a host of such code relationships wherein codes may be mutually exclusive of one another, or wherein a first code may be a component procedure of a second code, and it is therefore inappropriate to bill for both codes. While the motive of NCCI data is to reduce fraud and overpayment for medical services, one byproduct is difficulty and fear on the part of providers who may not be entirely sure whether they are submitting proper codes. If NCCI data is updated, it is a burden to stay abreast of the particular updates that apply to a particular provider's specialty.

Note that NCCI data is commonly used in the industry and is considered particularly useful for use with the invention, however as time goes on there may be other sources of useful data pertaining to relationships between procedure codes. Such other data sources are considered appropriate and workable data for inclusion in the context of the systems and methods herein. NCCI data serves as a good example of the potential features of such data.

The National Correct Coding Initiative data tables define the national correct coding methodologies based on coding conventions defined in the American Medical Association's CPT Manual, current standards of medical and surgical coding practice, input from specialty societies and analysis of current coding practice. In general NCCI edits are pairs of CPT or HCPCS Level II codes that are not separately payable except under certain circumstances. The edits are applied to services billed by the same provider for the same beneficiary on the same date of service. All claims are processed against the NCCI tables.

In the Comprehensive & Component table, the “comprehensive code” represents the major procedure or service when reported with another code. When reported with another code, “column 1” generally represents the code with the greater payment of the two codes.

Within the mutually exclusive edits table, “column 1” code generally represents the procedure or service with the lowest work RVU, and is the payable procedure or service when reported with another code

Just as with the other data sources described herein, NCCI data can be updated and stored locally in data storage 11, as shown in FIG. 1, or it can be retrieved from a remote location such as data source 15. Such a location could be, for example, the Centers for Medicare & Medicaid Services (CMS) website. CMS has posted on its website the automated edits used to identify questionable claims and adjust payments to reflect what would have been paid if the claim had been filed correctly.

Exemplary Fifth Data Source

Various embodiments may further comprise a fifth data source 16, which may comprise Local Medical Review Policy (LMRP) Data. Medicare/Medicaid is disbursed by local regional carriers. In some cases, there are multiple carriers per state, for example, in California. Other states may be serviced by a single carrier. These local carriers devise local rules to specify under what clinical circumstances a service is covered and correctly coded. This typically translates in to a listing of CPT codes that cannot be used in certain circumstances. For example, if a patient goes to a medical service provider with a broken finger, the patient should not typically leave having received an appendectomy. Compliance with LMRPs is an important part of submitting proper procedural codes to carriers for reimbursement. Providers are occasionally audited to determine whether they are in compliance, and if not, providers may be subject to civil and/or criminal liability.

There may be other data that is useful and/or mandatory in submitting proper codes to carriers, either Medicare, private insurance companies, or otherwise, and such other data is considered equally functional for inclusion in the systems and methods herein. In particular, Local Coverage Determination (LCD) and National Coverage Determination (NCD) data associated with a particular procedure code is considered likely and appropriate for inclusion with the various other useful data that may be transmitted to a provider for determination of appropriate coding.

To describe the general features of LMRP data, as both an administrative and educational tool, an LMRP assists providers in submitting correct claims for payment and outlines how claims will be reviewed to ensure that they meet Medicare coverage and coding requirements. Each LMRP must be consistent with all statutes, rulings, regulations and national coverage, payment and coding policies. Local carriers adopt LMRPs for a variety of reasons, and adequately tracking the LMRPs that apply to a particular provider is often very difficult. Among other difficulties, LMRPs are issued by local carriers that may not have the resources and brand recognition of national organizations, and may not present and distribute their LMRPs in a consistent and recognizable fashion. Some reasons a local carrier may have for developing LMRP's include but are not limited to the following:

A validated widespread problem demonstrating a significant risk of improper coding;

A need to assure beneficiary access to care;

Frequent claims denials for a particular service(s);

A local carrier is identified as an outlier in the reimbursement of a specific service;

Availability of new technology which presents a risk of improper coding;

Recognition of circumstances in which items or services should never be covered.

The establishment of a Carrier Advisory Committee (CAC) for each Medicare carrier is mandated by the Centers for Medicare and Medicaid Services (CMS). The purpose of the CAC is to provide a formal mechanism for physicians in the contractor's geographical jurisdiction to be informed of and participate in the development of an LMRP in an advisory capacity, a mechanism to discuss and improve administrative policies that are within carrier discretion, and a forum for information exchange between carriers and physicians.

Thus, while the process of adopting LMRPs is standardized to some extent, serious difficulties are present in many areas of the country when it comes to remaining abreast of LMRPs for a particular geographic region. By maintaining LMRP data for local carriers, this data can be provided along with any other coding data that is transmitted to providers in accordance with the invention.

For example, in various embodiments, a plurality of codes can be transmitted to a provider, and LMRPs that implicate each of the codes can be referenced on a page that lists the code. Because LMRPs vary by carrier, and therefore by geographic region, the LMRPs that are given to a first provider for a particular CPT code may differ from the LMRPs that are given to a second provider for the same code. The LMRPs for a provider in Texas are not the same as those for a provider in Washington state. Thus, the data storage 11 may be configured to cross reference CPT codes with the various LMRPs for each local carrier.

Exemplary Computing Device

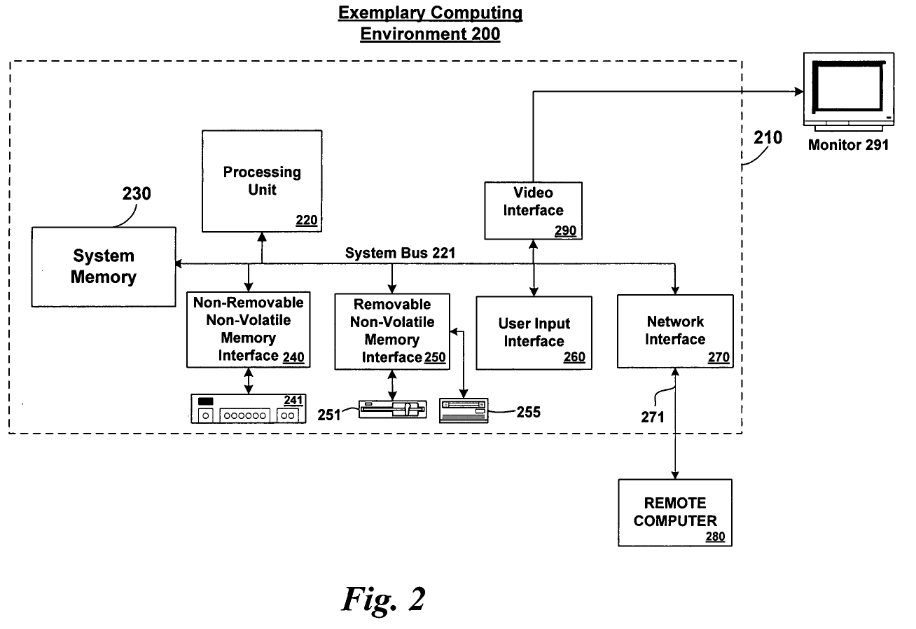

FIG. 2 and the following discussion are intended to provide a brief general description of a suitable computing environment in which aspects of the invention may be implemented. Forms that modern computing environments may take are very flexible, and while the invention is generally described here as implemented via a general use computer, such as computer 10 in FIG. 1, alternative arrangements are possible.

Referring to FIG. 2, an exemplary computer 210 may include, but is not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

A user may enter commands and information into the computer 210 through input devices such as a keyboard or pointing device, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB). A monitor 291 or other type of display device is also connected to the system bus 221 via an interface, such as a video interface 290, which may in turn communicate with video memory. In addition to monitor 291, computers may also include other peripheral output devices such as speakers and a printer, which may be connected through an output peripheral interface.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The computer 210 may also include other removable/non-removable, volatile/nonvolatile computer storage media. By way of example only, FIG. 2B illustrates a hard disk drive 241 that reads from or writes to non-removable, nonvolatile magnetic media, a magnetic disk drive 251 that reads from or writes to a removable, nonvolatile magnetic disk, and an optical disk drive 255 that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2B provide storage of computer readable instructions, data structures, program modules and other data for the computer 210.

The computer 210 may operate in a networked or distributed environment using logical connections to one or more remote computers, such as a remote computer 280. The remote computer 280 may be a personal computer, a server, a router, a network PC, a peer device or other common network node, and typically includes many or all of the elements described above relative to the computer 210. The logical connections depicted in FIG. 2B include a local area network (LAN) 271 via network interface 270, or alternatively a wide area network (WAN), but may also include other networks/buses. Such networking environments are commonplace in homes, offices, enterprise-wide computer networks, intranets and the Internet.

Software that is executed by a computer 210 may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols.

Exemplary Networked and Distributed Environments

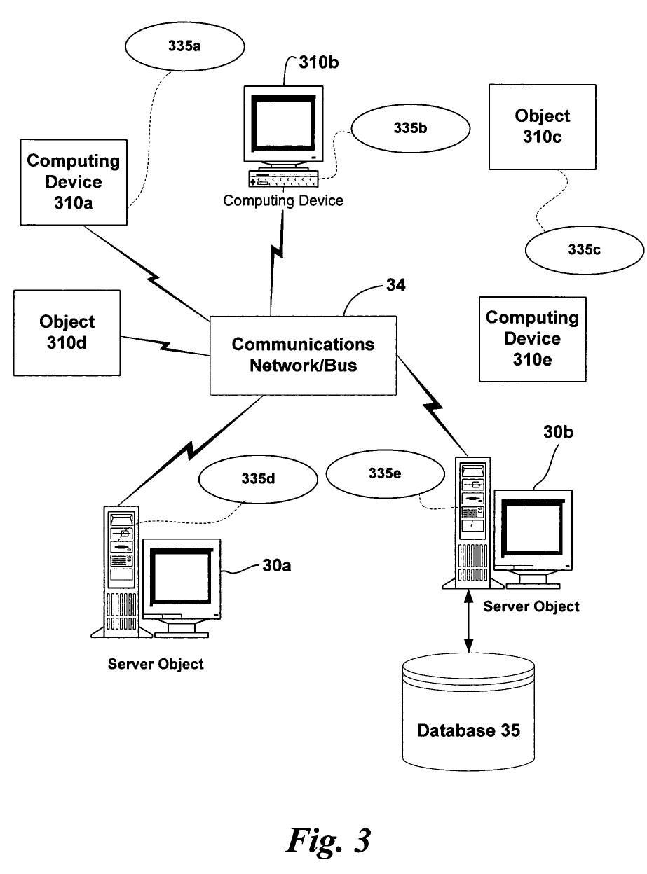

One of ordinary skill in the art can appreciate that a computer or other client or server device can be deployed as part of a computer network, such as that of FIG. 3, or in a distributed computing environment. Referring briefly back to FIG. 1, information may be transmitted over a network 18 at several points in the ordinary use of the invention. In particular computer 10 may retrieve data from data sources 12-16 from various locations on a network such as the internet. This data may optionally be stored locally in data storage 11. Next, the data is organized into appropriate collections for clients, which may access computer 10 via a network 18 using their client computer 17. Again, this network 18 could be the internet. However, network 18 could be any style or configuration of computer network, and FIG. 3 is provided to illustrate the features and broad definition ofjust what may be considered to be a computer network.

FIG. 3 provides a schematic diagram of an exemplary networked or distributed computing environment. The distributed computing environment comprises computing objects 30a, 30b, etc. and computing objects or devices 310a, 310b, 310c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 34. This network may itself comprise other computing objects and computing devices that provide services to the system of FIG. 3A. In accordance with an aspect of the invention, each object 30a, 30b, etc. or 310a, 310b, 310c, etc. may contain an application that might make use of an API, or other object, software or hardware, to request use of a resource for building a useful collection of coding data.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Distributed computing can help businesses deliver services and capabilities more efficiently across diverse geographic boundaries. Moreover, distributed computing can move data closer to the point where data is consumed acting as a network caching mechanism. Since data may in practice be physically located in one or more locations, the ability to distribute services that make use of the various data described herein is of great utility in such a system.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks.

Thus, FIG. 3A illustrates an exemplary networked or distributed environment, with a server in communication with client computers via a network/bus, in which the present invention may be employed. In more detail, a number of servers 30a, 30b, etc., are interconnected via a communications network/bus 34, which may be a LAN, WAN, intranet, the Internet, etc., with a number of client or remote computing devices 310a, 310b, 310c, 310d, 310e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to retrieve data of the types and in the formats described herein.

In a network environment in which the communications network/bus 34 is the Internet, for example, the servers 30a, 30b, etc. can be Web servers with which clients 310a, 310b, 310c, 310d, 310e, etc. communicate via any of a number of known protocols such as HTTP. Servers 30a, 30b, etc. may also serve as clients 310a, 310b, 310c, 310d, 310e, etc., as may be characteristic of a distributed computing environment. Communications may be wired or wireless, where appropriate. Client devices 310a, 310b, 310c, 310d, 310e, etc. may or may not communicate via communications network/bus 34, and may have independent communications associated therewith. Each client computer 310a, 310b, 310c, 310d, 310e, etc. and server computer 30a, 30b, etc. may be equipped with various application program modules or objects 335 and with connections or access to various types of storage elements or objects, across which files may be stored or to which portion(s) of files may be downloaded or migrated. Any computer 30a, 30b, 310a, 310b, etc. may be responsible for the maintenance and updating of a database 20 or other storage element in accordance with the present invention, such as a database or memory 20 for storing data queried according to the invention. Thus, the present invention can be utilized in a computer network environment having client computers 310a, 310b, etc. that can access and interact with a computer network/bus 34 and server computers 30a, 30b, etc. that may interact with client computers 310a, 310b, etc. and other like devices, and databases 35.

Selection of a Collection of Procedure Identifiers

Referring briefly again to FIG. 1, in an exemplary arrangement a user at computer 17 can access and display a user interface (UI) that is generated at computer 10. The UI allows the user to provide information that can be received by computer 10, and used to create a collection of medical coding data. The term “procedure identifier” may be used herein from time to time as well as in the appended claims to accurately describe what is commonly referred to in the industry as a code, billing code, or procedure code, and which in modern practice is often a CPT code. The collection of procedure identifiers can be compiled in a document by computer 10 and transmitted back to computer 17.

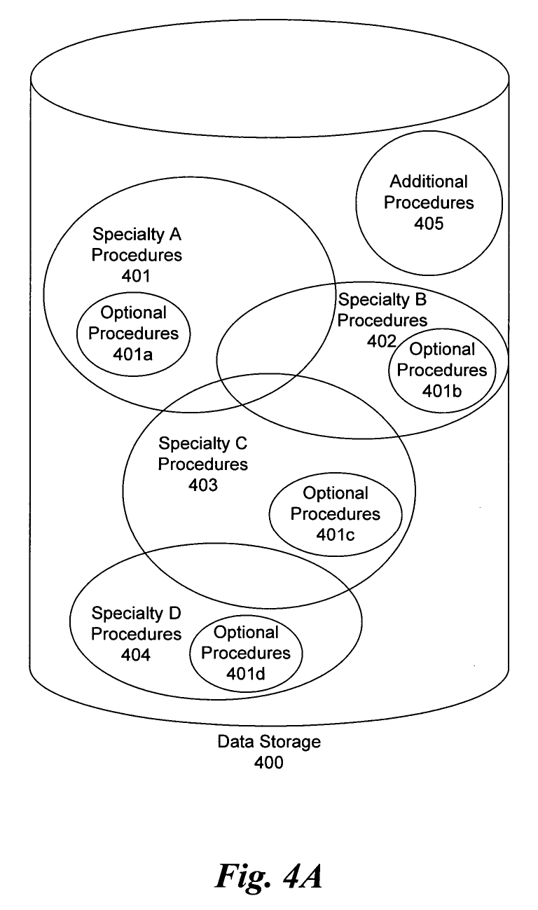

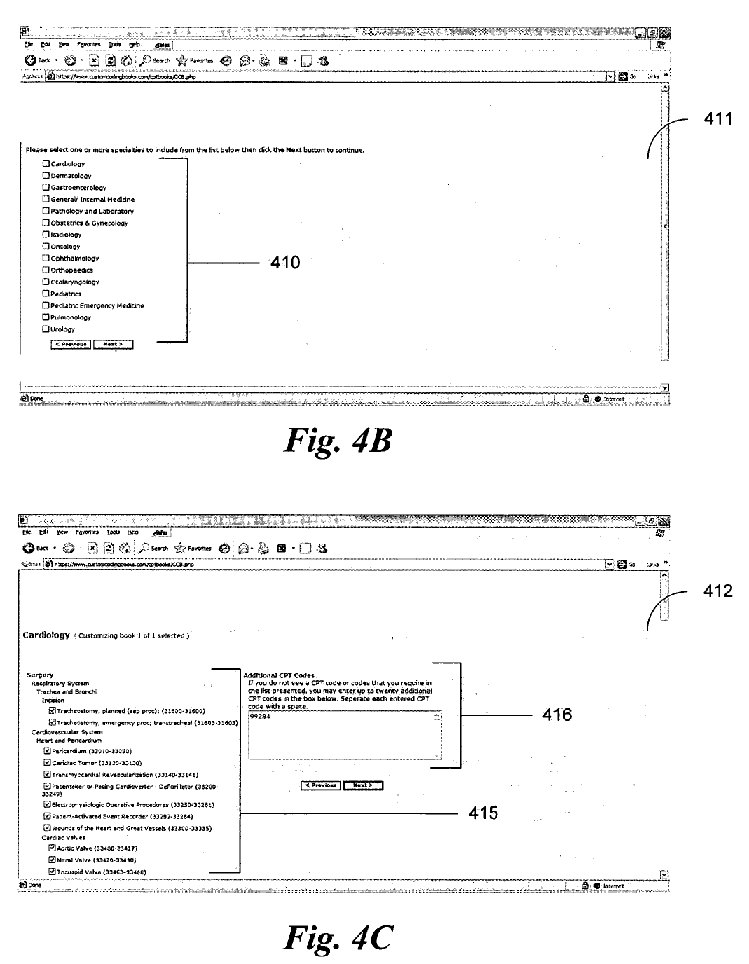

In this regard, one aspect of the invention may be a UI that allows selection of an appropriate subset of procedure identifiers. FIG. 4A illustrates an exemplary data storage 400 that contains medical coding data. The various procedure codes can be associated with any of a plurality of exemplary specialties 401, 402, 403, 404. When a user indicates a specialty through a UI, a process can retrieve the appropriate procedure identifiers along with any accompanying data from data store 400. Thus, one aspect of the invention may be to identify the various specialties that are likely to make use of a procedure identifier and classify the procedure identifiers accordingly.

When procedure identifiers are grouped by specialty, a UI can present a specialty to a user and the user can automatically indicate an interest in an associated collection of procedure identifiers by selecting the specialty. Such a UI 411 is illustrated in FIG. 4B. For example, the cardiology specialty in FIG. 4B might correspond to the procedure identifiers of specialty A 401 in FIG. 4A.

Some of the codes associated with a specialty, for example optional procedures 401a which are associated with specialty A procedures 401, or analogous optional procedures 402a, 403a, and 404a associated with specialty procedures B, C, and D, respectively, can be optionally included in a useful collection of procedure identifiers. In various embodiments, a set of procedure identifiers may be presented to a user when the user identifies a specialty. The procedure identifiers that are considered very likely needed by providers of the selected specialty can be automatically selected in the UI, e.g. by automatically checking appropriate boxes, such as the selected boxes in FIG. 4c. Other, less likely procedure identifiers can not be automatically selected, but can nonetheless be presented to the user in a UI, see FIG. 4C, so that users can easily include them in their collection. These deselected specialties can correspond to optional procedures, e.g. 401a in FIG. 4A. Procedures that are not used in the selected specialty need not be displayed at all, because such display may simply distract from the useful presentation of procedures that are likely needed.

Note that in embodiments where some procedure identifiers are not displayed at all in a UI such as that of FIG. 4C, the UI may present an area 416 for entry of additional procedure identifiers. Thus, procedures can be accommodated that are not typically performed by most providers of the selected specialty, while the primary UI for the specialty is not diluted with numerous procedures that are not typically needed. Once a collection of procedures is identified by selecting a specialty, any optional procedures, and any additional procedures, all appropriate procedure identifiers can be compiled into a document and the document can be transmitted back to the user. As alluded to with reference to the data sources described above, the document can include both the procedure identifiers of the collection and additional useful information.

Exemplary Steps to Produce a Useful Collection

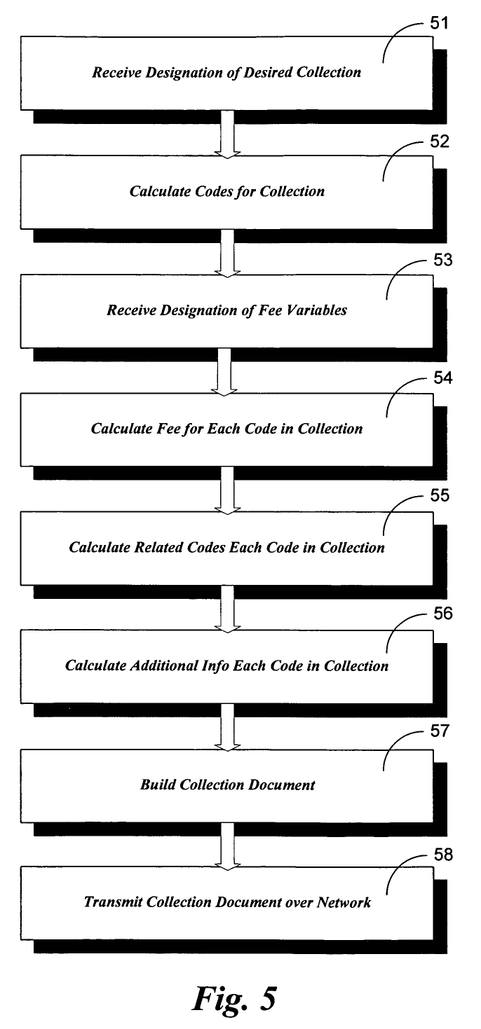

FIG. 5 illustrates a series of steps that may be engaged to provide a user with a useful collection of procedure identifiers along with related data to facilitate the use of the identifiers. In general, the steps 51-58 may be carried out by a computer, such as computer 10 from FIG. 1. The steps 51-58 may be summarized as receiving information from a user and generating a document with a collection of codes pertaining to the user's specialty. The codes can be associated with fees calculated according to the user's circumstances, and with any mutually exclusive and/or local codes that may be needed by a particular user.

More particularly, a computer hosting an application for carrying out aspects of the invention may receive a designation of desired collection 51. This designation may be made, for example, by a user through the UI elements presented in FIGS. 4B and 4C. Note that the invention is not limited to the embodiments of FIGS. 4B and 4C, and other implementations for designating a collection of codes may be implemented. Once the collection is identified, the computer may proceed to calculate codes for the collection 52, for example by identifying all the codes in the collection in a list and storing the list in system memory. After determining the codes of a collection that is needed by a particular provider, the additional information that is usefully associated with the codes can be retrieved.

Some of such useful information may depend on user-specific data. In this regard, the user may be prompted to enter and transmit a designation of fee variables, which may then be received at the computer in step 53. In some embodiments, a user account may be set up and such user specific variables can be stored permanently in a file so that the user need not re-enter the information to receive subsequent updates to the information.

Presently, the fee for the various procedures is dependent on at least one user variable, namely geographic location. As described above with reference to the GPCI data, fees can be calculated using GPCIs in conjunction with RVUs that are associated with each procedural identifier. Thus, the fee for each code in the collection may be calculated 54 as a next step. This may be accomplished by looking up the appropriate RVU information for each code in the collection, and by multiplying the RVU by a GPCI that corresponds to the user's geographic location. The appropriate GPCI can be identified in a number of ways, for example the user may be prompted to enter their zip code, the county they live in, the city they live in, and so on. A table can be stored that correlates zip codes, counties, cities, and the like to appropriate GPCI numbers.

Related codes may be also calculated for each code in the collection 55. The related codes may be, for example NCCI codes. A table may be kept that gives an updated version of all NCCI codes, be they mutually exclusive or component codes, for a given procedural identifier. The appropriate NCCI codes may be determined by referring to such a table. LMRPs may also be retrieved in this step. Although the LMRPs are not technically “codes” themselves, but rather local rules, they may supply code relationships and they may be identified by a numeric value. Once again, a table may be kept that keeps up-to date records of all LMRPs that are associated with a particular procedure identifier. Because the LMRPs vary based on carrier, which is a function of geographic location, the appropriate LMRPs may be found by first limiting a query to LMRPs for a particular carrier, as determined from a user's zip code, county, or the like, and then searching for the appropriate LMRPs for each code in the collection. Of course, this order may be reversed.

Calculating additional info for each code in the collection 56 may be as simple or as involved a process as desirable. In various preferred embodiments, a certain amount of additional info may be kept with the procedure identifiers, and this info may simply be placed into a document in an appropriate location along with the other useful information described herein. This information can comprise a description of the procedure associated with a code, any associated notes, and any special rules that should be made clear about the use of the code. Other embodiments may provide a more extensive search and retrieval of other data sources to provide as thorough information as possible about each code in the collection. Still other embodiments may provide an arrangement where advertisers are permitted to supply product information and the like to be displayed along with codes that identify procedures that may benefit from the advertised product.

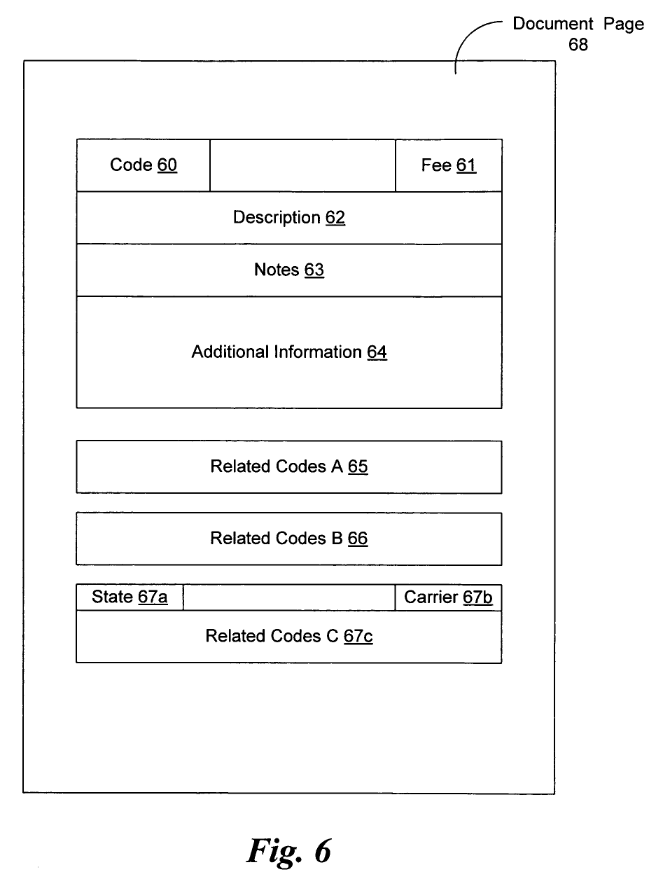

Finally, with reference to FIG. 5, a collection document may be built 57 and transmitted over a network 58 to the provider that requested the document. While the collection document may take many forms, preferred embodiments can make use of several advantageous formatting features. These features are described with reference to FIG. 6, below. Exemplary Document for Procedure Identifiers and Related Information

FIG. 6 illustrates an exemplary page of a document that may be associated with one procedural identifier, also referred to herein as a code, in a collection of codes that is transmitted to a medical services provider. The collection may comprise any number of codes. The set of codes in the collection can be selected by a user as described above. Each code in the collection may be represented on a page such as the page 68 of FIG. 6. The pages may be included in a single paginated document, or may be broken into a plurality of documents. Many electronic formats exist for documents, and those of skill will acknowledge that such a document could be, for example, a simple text (.txt) file, a MICROSOFT WORD® (.doc) file, a COREL WORD PERFECT® (.wpd) file, an ADOBE® portable document (.pdf) file, or any other electronic document format.

Various embodiments of the invention limit may preferably be arranged to display a single code, with the related information for that code, on a single page of the document, as shown in FIG. 6. This is because the document will likely be printed for easy reference by medical providers. When updates are made to the codes of a provider's collection, an update file can be sent to the provider with a plurality of new and/or replacement pages. By limiting the codes to one per page, updating a printed document is easy. Old pages can be removed and new pages can be inserted, without risk of loosing code information or keeping out of date information. Thus, while a one code per page arrangement is not required, it may be preferable.

The page 68 may identify a procedure code 60, a permissible fee 61 for the associated procedure 62, and various notes 63, additional information 64 and related codes 65-67. The fee 61 may be the fee that is calculated for a particular provider who requested the collection. As described above, fees for the same procedure differ based on the circumstances of individual providers. These circumstances may be accounted for in calculating the fee 61 for the code 60.

The procedure 62, notes 63, and additional information can be pulled from additional data that may be associated with each code. As noted above, there is an abundance of data that may be useful to supply on a page 68, including advertising or other information. The invention is not limited to the data elements on page 68.

Related codes 65 may be, for example, a listing of codes that are mutually exclusive with the code 60. Codes that are mutually exclusive may be determined by any manner, and can include mutually exclusive codes determined by the NCCI pairs. Related codes 66 can be, for example, a listing of codes that are component/comprehensive of code 60. Again, this determination may be made in any number of ways as may provide a useful listing for a provider, and in modern practice will likely include the NCCI component/comprehensive codes for the code 60.

Related codes 67c can be the LMRPs for code 60. While LMRPs are not themselves codes, they do provide rules and regulations for codes that may specify related codes in an NCCI type listing of incompatible codes. LMRPs may be listed by an identifier for the regulation number along with a short written description of the content of the LMRP. To further describe the LMRPs for code 60, the state 67a and carrier 67b may be listed adjacently to the LMRP section. This provides assurance to a provider that the LMRPs listed in 67c are in fact the LMRPs that correspond to the provider's local carrier.

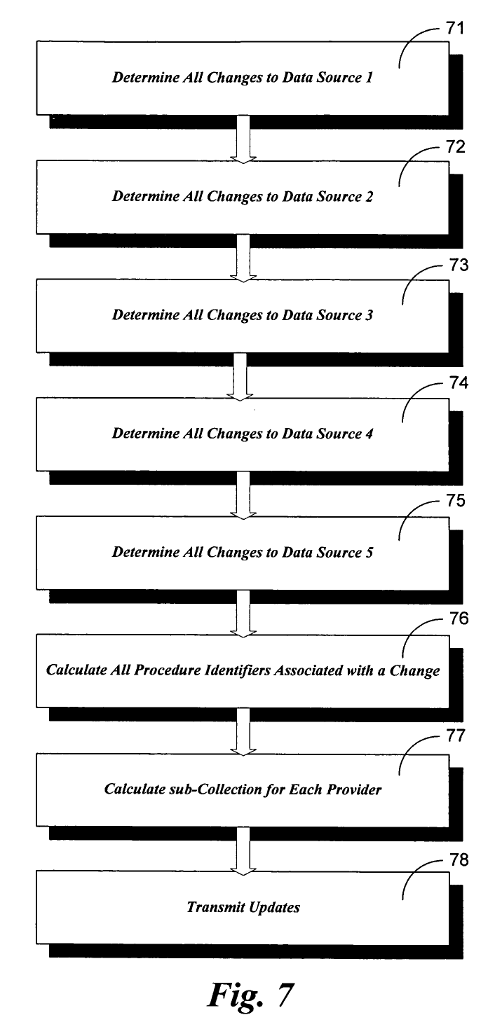

FIG. 7 illustrates exemplary steps that may be carried out in updating a document with a collection of procedure identifiers. Updating such a document can be conducted whenever any of the data sources 12-16 from FIG. 1 are modified, or can occur at regular intervals, such as monthly, quarterly, biannually, yearly, or the like. In embodiments where updates are sent at regular intervals, a plurality of changes may have been made to the data of a particular provider's collection. The problem, in this scenario, is to identify all of the pages, such as page 68 from FIG. 6, that contain data that has been changed since a previous update, and to calculated and send updated pages to a user. This problem can be solved, for example, by following the steps set forth in FIG. 7.

First, a process, for example an application on computer 10 from FIG. 1 can determine all changes to data source 1 71, or, as the case may be, corresponding changes to a local storage, such as 11 from FIG. 1. Next, similar inspection can be conducted with respect to the other data sources, e.g. in steps 72, 73, 74, and 75. In any additional data sources are present, these may similarly be inspected for any changes since a last update. Once the changed data is identified, for example by comparing an old version of the various data sets to a new version, all procedure identifiers associated with a change can be calculated 76. Once the procedure identifiers associated with changed data are identified, determination of the contents of an update for a particular provider may entail determining which procedure identifiers are in the provider's collection, and comparing them to the procedure identifiers that are associated with changed data. This step is referred to in FIG. 7 as determining a sub-collection for each provider 77. It may be followed by compiling the sub-collection into a document, such as a .pdf, and transmitting the document to a user 78.

In scenarios where changes in medical coding data include new procedure identifiers, the procedures associated with the new identifiers can be assigned to one or more specialties, and any providers with the assigned specialties can receive the new identifiers in an update. Note that there are a variety of techniques for calculating changes for determination of updates, and the invention is not limited to the particular embodiments described here.

Exemplary Configuration of Various Aspects

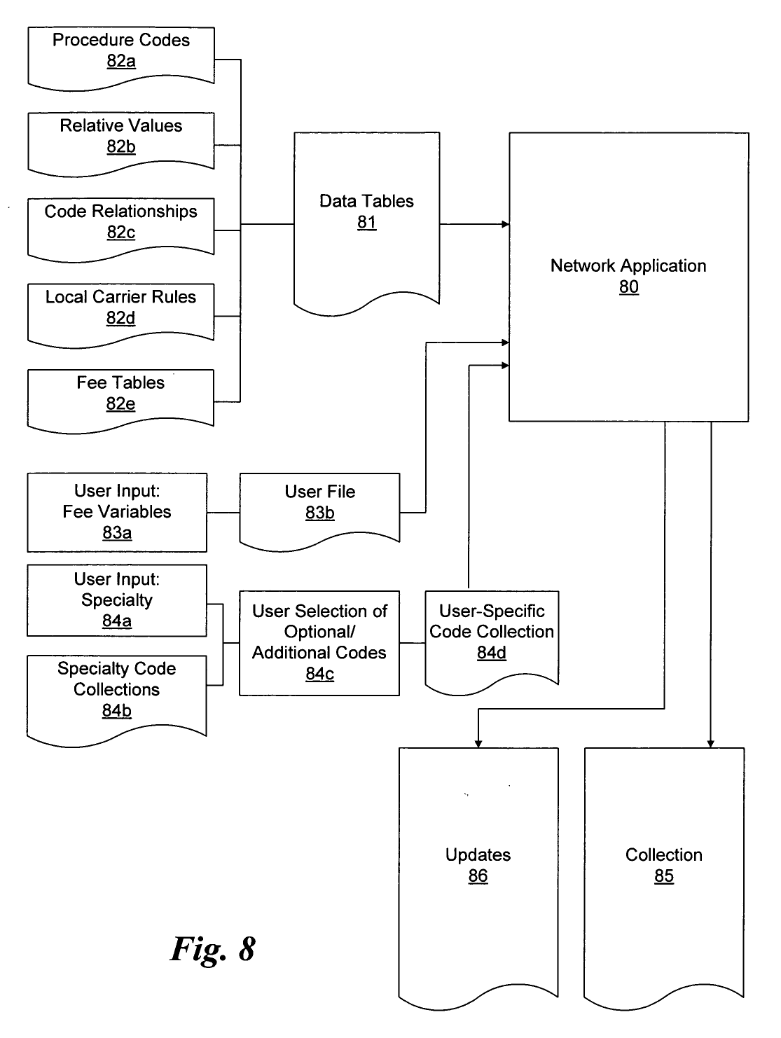

FIG. 8 illustrates aspects of various embodiments of the invention in which a network application 80 can access data tables 81 that may comprise codes and other data from a plurality of sources 82a-82e. The network application 80 may accept input such as fee variables 83a and a plurality of codes associated with a specialty designation 84a. The network application 80 may generate a document 85 in which data from 82a-82e is conveniently associated with codes of the collection specified by the user. Moreover, the network application 80 may send out updates 88 as the data in 82a-82e changes, or on a regular interval, such as quarterly.

In the embodiments of FIG. 8, data is collected from 5 sources 82a-82e for presentation to the user: these five sources may be procedure codes 82a such as the CPT® codes, relative values 82b associated with the procedures 82a, such as the RVU tables, code relationships 82c, for example the NCCI component/comprehensive code combinations, local carrier rules 82d such as the LMRP requirements for code/diagnosis combinations, and finally fee tables 82e to properly calculate fees based on provider-specific variables, such as the GPSCI regional price indexes. These five data blocks may be maintained in a centralized location such as raw data tables 81 that are accessible by a network application 80 that may provide both a UI and appropriate processing for retrieving and compiling data from 81 into a collection document.

A user may access the network application 80 and enter provider-specific information to obtain tailored coding data. First, the user may provides a medical specialty 84a. Procedure codes can be associated with a plurality of specialties in a plurality of specialty code collections 84b. The collections 84b may be located in data storage that is accessible by network application 80. The collections 84b may be broken into very likely needed codes that are automatically selected when a user indicates a specialty, and optional codes that a user can opt to have included in their particular collection, for example through a UI window as illustrated in FIG. 4C.

To compile a particular collection 85 for a provider, the network application 80 may retrieve procedure codes and place each on one page of a paginated document, such as a .pdf document. Updates 86 may then comprise new and/or replacement pages, as needed. The provider may print update pages as they become available without reprinting the entire collection 85. For each procedure code in the collection, a fee can be calculated, and any assortment of additional useful information may also be retrieved and provided.

Calculating the fee can comprise first determining circumstantial information about a user, because the fee for a particular procedure code is not fixed. Instead, the fee may depend on variables. For example, each procedure code may have an RVU, and the appropriate fee for an associated procedure can be calculated by multiplying the RVU by the GPCI number for that code. A physician's GPSCI can be determined based on the physician's location. This information can be determined from location data entered into the system by a provider. Such location information is an example of a fee variable 83a, e.g. a zip code, county, state or provider-specific circumstantial information. The fee variables 83a can be stored for later use in a user file 83b, so need not be reentered every time the provider makes use of the network application 80.

Calculating the additional useful information, such as LMRPs, and NCCIs can comprise retrieving additional information associated with a particular CPT® code. This information can be referenced in a database to properly related all data for retrieval and packaging with corresponding procedure codes.

For further and accurate disclosure of an embodiment of a custom collection of procedure codes, APPENDIX A is attached. The following copyright notice applies to the materials of APPENDIX A: © 2003 Custom Coding Books, LLC.

Appendix A:

What is claimed:

1. In a system comprising at least one computing device operably connected to one or more additional computing devices in a computer network, a method for providing a useful set of data, comprising:
receiving an indication of a first specialty;
retrieving a plurality of first procedure identifiers for procedures associated with the first specialty;
receiving an indication of a geographic location;
calculating a fee for at least one of the plurality of first procedure identifiers, wherein the fee depends on the geographic location;
transmitting the plurality of first procedure identifiers and the fee for at least one of the plurality of first procedure identifiers.

2. The method of claim 1, further comprising creating a paginated document with a page for each of said plurality of first procedure identifiers.

3. The method of claim 2, wherein said paginated document is in portable document format.

4. The method of claim 1, wherein said indication of a first specialty identifies a medical services provider specialty.

5. The method of claim 4, wherein the plurality of first procedure identifiers is a plurality of billing codes that correspond to medical procedures.

6. The method of claim 1, further comprising retrieving at least one procedure identifier that is not concurrently reimbursable with at least one of said plurality of first procedure identifiers.

7. The method of claim 6, further comprising associating the at least one procedure identifier that is not concurrently reimbursable with the at least one of said plurality of first procedure identifiers by placing the at least one procedure identifier that is not concurrently reimbursable on a same page in a document as the at least one of said plurality of first procedure identifiers.

8. The method of claim 1, wherein the indication of a geographic location is a zip code.

9. The method of claim 1, wherein an indication of a geographic location is a county name.

10. The method of claim 1, wherein an indication of a geographic location is a city name.

11. The method of claim 1, further comprising using the indication of a geographic location to determine a Medicare carrier.

12. The method of claim 11, further comprising retrieving at least one local Medicare carrier rule for at least one of the plurality of first procedure identifiers.

13. The method of claim 1, further comprising determining if any data associated with the plurality of first procedure identifiers has changed.

14. The method of claim 13, further comprising calculating all of the procedure identifiers in said plurality of first procedure identifiers that are associated with changed data.

15. The method of claim 14, further comprising transmitting the procedure identifiers that are associated with changed data.

16. In a system comprising at least one computing device operably connected to one or more additional computing devices in a computer network, a means for providing a useful set of data, comprising:
means for receiving an indication of a first specialty;
means for retrieving a plurality of first procedure identifiers for procedures associated with the first specialty;
means for receiving an indication of a geographic location;
means for calculating a fee for at least one of the plurality of first procedure identifiers, wherein the fee depends on the geographic location;
means for transmitting the plurality of first procedure identifiers and the fee for at least one of the plurality of first procedure identifiers.

17. The means of claim 16, further comprising means for creating a paginated document with a page for each of said plurality of first procedure identifiers.

18. The means of claim 17, wherein said paginated document is in portable document (.pdf) format.

19. The means of claim 16, wherein said indication of a first specialty identifies a medical services provider specialty.

20. The method of claim 19, wherein the plurality of first procedure identifiers is a plurality of billing codes that correspond to medical procedures.

21. The means of claim 16, further comprising means for retrieving at least one procedure identifier that is not concurrently reimbursable with at least one of said plurality of first procedure identifiers.

22. The method of claim 21, further comprising means for associating the at least one procedure identifier that is not concurrently reimbursable with the at least one of said plurality of first procedure identifiers by placing the at least one procedure identifier that is not concurrently reimbursable on a same page in a document as the at least one of said plurality of first procedure identifiers.

23. The means of claim 16, wherein the indication of a geographic location is a zip code.

24. The means of claim 16, wherein an indication of a geographic location is a county name.

25. The means of claim 16, wherein an indication of a geographic location is a city name.

26. The means of claim 16, further comprising means for using the indication of a geographic location to determine a Medicare carrier.

27. The method of claim 26, further comprising means for retrieving at least one local Medicare carrier rule for at least one of the plurality of first procedure identifiers.

28. The means of claim 16, further comprising means for determining if any data associated with the plurality of first procedure identifiers has changed.

29. The method of claim 28, further comprising means for calculating all of the procedure identifiers in said plurality of first procedure identifiers that are associated with changed data.

30. The method of claim 29, further comprising means for transmitting the procedure identifiers that are associated with changed data.

31. A computer system for supplying a graphical user interface (GUI) for specifying a collection of medical coding data, the GUI comprising:
a plurality of selectable medical specialties for display in said GUI;
a plurality of selectable procedure identifiers, wherein said selectable procedure identifiers are presented in the GUI upon selection of at least one of said plurality of selectable medical specialties;
an area for entry of at least one procedure identifier that is not presented in the GUI upon selection of at least one of said plurality of selectable medical specialties;
a geographic location entry area.

32. The GUI of claim 31, wherein at least one of the plurality of selectable medical specialties, the plurality of selectable procedure identifiers, the area for entry of at least one procedure identifier, and the a geographic location entry area is located on a webpage that is linked to one or more of the other GUI elements for navigation to the one or more of the other GUI elements.

33. The GUI of claim 31, further comprising a selectable function for compiling a document comprising a selected number of said selectable procedure identifiers.

34. The GUI of claim 33, wherein said document comprises at least one page for each of said selected number of selectable procedure identifiers.

35. The GUI of claim 33, wherein said document comprises a fee for at least one of said selected number of selectable procedure identifiers.

36. The GUI of claim 35, wherein said fee is calculated using a geographic location entered in said geographic location entry area.

37. A document for use in determining appropriate medical coding data, comprising:
a plurality of procedure identifiers, wherein substantially each of the plurality of procedure identifiers is associated with a collection of procedures that corresponds to a medical specialty;
a plurality of pages, wherein at least one page is dedicated to a single procedure identified by one of the plurality of procedure identifiers;
at least one fee for said single procedure on said at least one page in the document, wherein the at least one fee is calculated using a number that corresponds to a geographic location of a medical provider.

38. The document of claim 37, further comprising at least one procedure identifier that identifies a procedure that is not concurrently reimbursable with the single procedure identified by one of the plurality of procedure identifiers.

39. The document of claim 38, wherein the procedure that is not concurrently reimbursable is a procedure that is mutually exclusive with the single procedure identified by one of the plurality of procedure identifiers.

40. The document of claim 38, wherein the procedure that is not concurrently reimbursable is a component of the single procedure identified by one of the plurality of procedure identifiers.

41. The document of claim 38, wherein the procedure identifier that identifies a procedure that is not concurrently reimbursable is placed on the at least one page.

42. The document of claim 37, further comprising at least one identification of a local rule that pertains to the single procedure identified by one of the plurality of procedure identifiers.

43. The document of claim 42, wherein the at least one identification of a local rule is placed on the at least one page.

44. A means for generating a document for use in determining appropriate medical coding data, comprising:
means for retrieving a plurality of procedure identifiers, wherein substantially each of the plurality of procedure identifiers is associated with a collection of procedures that corresponds to a medical specialty;
means for generating a plurality of pages, wherein at least one page is dedicated to a single procedure identified by one of the plurality of procedure identifiers;
means for placing at least one fee for said single procedure on said at least one page in the document, wherein the at least one fee is calculated using a number that corresponds to a geographic location of a medical provider.

45. The means for generating a document of claim 44, further comprising means for retrieving at least one procedure identifier that identifies a procedure that is not concurrently reimbursable with the single procedure identified by one of the plurality of procedure identifiers.

46. The means for generating a document of claim 45, wherein the procedure that is not concurrently reimbursable is a procedure that is mutually exclusive with the single procedure identified by one of the plurality of procedure identifiers.

47. The means for generating a document of claim 45, wherein the procedure that is not concurrently reimbursable is a component of the single procedure identified by one of the plurality of procedure identifiers.

48. The means for generating a document of claim 45, wherein the procedure identifier that identifies a procedure that is not concurrently reimbursable is placed on the at least one page.

49. The means for generating a document of claim 44, further comprising means for retrieving at least one identification of a local rule that pertains to the single procedure identified by one of the plurality of procedure identifiers.

50. The means for generating a document of claim 49, wherein the at least one identification of a local rule is placed on the at least one page.
